(19) United States
(12) Patent Application Publication
(10) Pub. No.: US 2013/0259793 A1
(43) Pub. Date: Oct. 3, 2013

(54) Method for Obtaining or Recovering Nitric Acid and Hydrofluoric Acid from Solutions of Stainless Steel Pickling Systems

(71) Applicants: Gerhard Frithum, Traiskirchen (AT); Herbert Klausner, Mauerbach (AT); Wilfried Szokol, Modling (AT); Fabian Storek, Wien (AT)

(72) Inventors: Gerhard Frithum, Traiskirchen (AT); Herbert Klausner, Mauerbach (AT); Wilfried Szokol, Modling (AT); Fabian Storek, Wien (AT)

(73) Assignee: KEY TECHNOLOGIES INDUSTRIEBAU GMBH, Klosterneuburg (AT)

(21) Appl. No.: 13/642,720

(22) PCT Filed: Apr. 18, 2011
(86) PCT No.: PCT/AT2011/000188

§ 371 Date: Jun. 3, 2013

(30) Foreign Application Priority Data
Apr. 20, 2010 (AT) A 640/2010

(51) Int. Cl. C01B 21/46; C01B 7/19

(52) U.S. Cl. CPC C01B 21/46; C01B 7/195
USPC 423/394.2; 423/484

(57) ABSTRACT

A method for obtaining or recovering acids, in particular nitric acid and hydrofluoric acid, from solutions and/or metal salts of these acids containing solutions, comprising the steps of: a) spray-drying the solutions at temperatures below the decomposition temperature of the acids, the requisite energy for which is introduced via a gaseous heat-transfer medium, in order to obtain dry metal salts and gaseous acids; b) absorbing the gaseous acids formed in step a); c) separating out the dry metal salts formed in step a); optionally d) roasting the dry metal salts obtained in step a) at temperatures in the range from 400 to 900° C., in order to obtain metal oxides and gaseous acids; and e) absorbing the gaseous acids formed in step d).

The present invention relates to a method for obtaining or recovering acids from solutions and/or metal salts of these acids, containing solutions from stainless steel pickling systems, preferably fluorides and optionally nitrates of Fe, Cr, Ni.

Methods for recovering acids, in particular from nitric acid solutions and hydrofluoric acid solutions or from metal-containing nitric acid solutions and hydrofluoric acid solutions from steel processing are known in the prior art. A survey of these methods is provided in EP 0 296 147.

For instance, crystallization methods can be employed, as described in OE 335 251 or EP 0 984 078. In them, the metal-containing acid solutions are concentrated by evaporation, and the acids are distilled off in this way; when the saturation limit is exceeded, the metal salts, predominantly fluorides, in the distillation bottom crystallize out. They are separated out, and the mother liquor is combined with the distilled-off acids and returned to the cycle. However, some content of metal salts then still remains in the regenerated pickling solution and increases further over the course of processing until the limit of solubility is reached. This markedly increases the formation of pickling sludge, and the influence of such solutions on the pickling behavior is as yet unexplained. The metal salt crystals separated out in the regeneration cannot be obtained in a dry, free-flowing state in this way; they are “wet”, since they still contain some metal salts dissolved in water (mother liquor) and have more or less high acid contents, which can be removed only by complicated washing operations.

Reclaiming the crystals is therefore problematic, and transporting and processing them moreover requires special corrosion-proof systems, since the metal salts dissolved in water that are contained or are adherent act as an electrolyte, which is known to be responsible for the corrosion of system parts. Moreover, these “wet” crystals are distinguished by generally poor transportability.

Pyrohydrolytic methods are also known in the prior art, as described for instance in AT 412 001, EP 0 296 147, or EP 1 038 991. In them, the metal-containing acid solutions as such, or in already concentrated form, once some proportion of the acids has been evaporated off, as described for example in AT 412 001 or EP 1 038 991, are treated essentially at temperatures of from 450 to 900° C. in single- or multiple-zone spray-roasting reactors. The disadvantage of these methods is that as a result of this type of heat treatment, a majority of the remaining nitric acid is decomposed into NO and NO₂. The recovery rate of nitric acid in these methods is therefore limited to approximately 60%, unless additional provisions are made, such as an additional oxidation step, as described in EP 0 296 147. Then hydrogen peroxide is required for the oxidative treatment of the NOx, which takes place in an additional requisite oxidation tower, to increase the yield of recovered nitric acid.

The object of the present invention is to furnish an alternative method for obtaining or recovering acids, in particular nitric acid and hydrofluoric acid, from solutions from stainless steel pickling systems containing solutions and/or metal salts, preferably Fₑ, Cᵣ, and Nᵢ salts, of these acids, in which nitric acid and water are separated off gently, even before an optional ensuing roasting or pyrohydrolysis step, without decomposition of the nitric acid, and dry, free flowing metal salts in crystalline form are obtained.

As a result, compared to the methods known in the prior art,

1) the recovery rate for the nitric acid is increased from approximately 50% to over 95%, without requiring additional provisions for generating nitric acid from NOx that has formed;

2) the formation of NOx in the exhaust gas is thus practically prevented, resulting in substantially less investment, expense, and fuel consumption, since there is no need for a complicated method for removing the NOx from the exhaust gas, for instance by means of NO removal processes;

3) obtaining dry, free-flowing metal fluorides is made possible, and therefore the ensuing method steps can be performed easily and inexpensively, especially since because of the absence of a (liquid) electrolyte, anti-corrosion provisions are hardly necessary;

4) there is no metal-containing mother liquor that subsequently has to be separated treated, or that on being mixed with the regenerated acid solution creates a pickling solution which already has a “minimum” metal content;

5) no addition of conveyor additives in roasting the dry metal salts is necessary;

6) adding oxide to the fluorides is superfluous, leading on the one hand to considerable energy savings in the roasting process and on the other to a considerably smaller specific system size.

These objects are attained by the method according to the invention for obtaining or recovering acids, in particular nitric acid and hydrofluoric acid, from solutions and/or metal salts of these acids containing solutions, including the steps of

a) spray-drying the solutions at temperatures below the decomposition temperature of the acids, the requisite energy for which is introduced via a gaseous heat-transfer medium, in order to obtain dry metal salts and gaseous acids;

b) absorbing the gaseous acids formed in step a);

c) separating out the dry metal salts formed in step a); optionally

d) roasting the dry metal salts obtained in step a) at temperatures in the range from 400 to 900° C., in order to obtain metal oxides and gaseous acids; and

e) absorbing the gaseous acids formed.

In an advantageous embodiment of the invention, the temperature of the gaseous heat transfer medium in method step a) is in the range from 180 to 500° C., preferably from 300 to 400° C., and even more highly preferably it is approximately 350° C. As a result, during the spray-drying, the decomposition temperature of nitric acid, which begins to decompose at about 160° C., is not exceeded, with the result that no NOₓ is formed.

The metal salts emerging from the spray-drying, primarily fluorides of the corresponding metals, are dry and free-flowing.

In an advantageous embodiment of the invention, the temperature in the roasting step d), at which the dry metal salts obtained in the spray-drying process, primarily fluorides, are reacted pyrohydrolytically, for instance in a revolving cylindrical furnace, into metal oxide, is in the range from 500 to 800° C., preferably from 650 to 750° C., and even more highly preferably it is approximately 700° C. The products of the roasting process are the corresponding metal oxides and gaseous acid, primarily hydrofluoric acid, which is absorbed in the ensuing step.

In still another advantageous embodiment of the invention, the absorbing of the gaseous acids, that is, the nitric acid and the hydrofluoric acid, obtained in method steps b) or e) takes place in water. The thus-regenerated acids are recovered exclusively from the vapor phase, in that the gaseous acids are put in solution in one or more absorption stages downstream of the spray dryer or roasting reactor. At the same time, the acid content can be increased by ejecting water vapor.

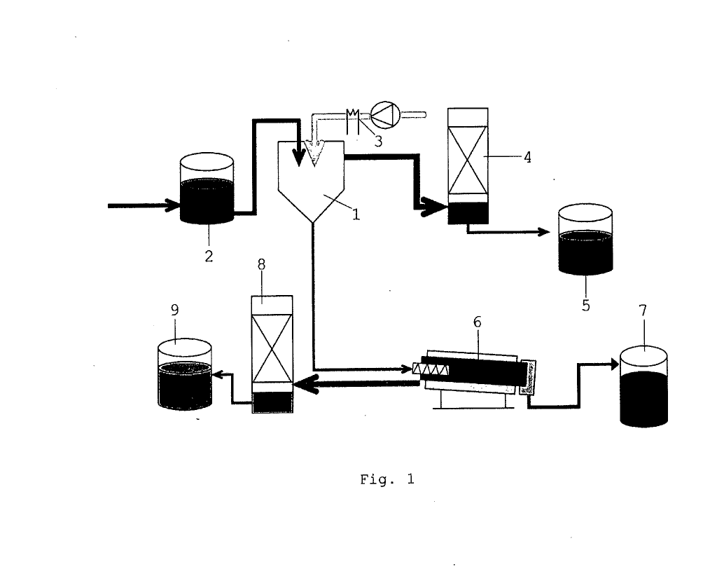

For better comprehension of the invention, the invention will be explained hereinafter in conjunction with FIG. 1.

FIG. 1 shows a schematic system for performing the method of the invention.

The regeneration system comprises a spray dryer 1, which is fed from a mixed-acid tank 2. In the spray dryer, preheated air 3 is introduced (180° C. to 500° C.), preferably air at approximately 350° C., and the mixed acid is sprayed into the spray dryer 1 by means of a one- or two-fluid nozzle or nozzles (not shown). The exhaust gas emerging from the spray dryer at approximately 140° C. primarily comprises nitric acid, which after a quench in an ensuing absorption column 4 is washed out of the pickling process (not shown) by means of rinsing water. The nitric acid thus obtained is pumped from the absorption column 4 into a tank 5, in order to be reused in the pickling process.

At the bottom of the spray dryer 1, the dry and free-flowing metal salts, primarily fluorides, are discharged and introduced into an ensuing roasting reactor 6. For that purpose, as shown, an indirectly heated rotating cylinder is used, and a mixture of steam and air, in a suitable composition for the roasting reaction, is introduced into the roasting chamber, and roasting (pyrohydrolysis) takes place at approximately 700° C.

The resultant metal oxide is fed into an oxide container 7.

The gaseous acid thus created primarily comprises hydrofluoric acid (HF) and is carried into a further absorption column 8 and from there is pumped as an aqueous solution into a tank 9, so as to be used again in the pickling process.

Via the top of the absorption columns 4, 8, water vapor and possibly traces of NOₓ and HF are ejected, which can be treated in a known manner if needed and emitted into the environment while meeting applicable environmental protection standards.

1. A method for obtaining or recovering acids, in particular nitric acid and hydrofluoric acid, from solutions and/or metal salts of these acids containing solutions, comprising the steps of:
a) spray-drying the solutions at temperatures below the decomposition temperature of the acids, the requisite energy for which is introduced via a gaseous heat-transfer medium, in order to obtain dry metal salts and gaseous acids;
b) absorbing the gaseous acids formed in step a);
c) separating out the dry metal salts formed in step a); optionally
d) roasting the dry metal salts obtained in step a) at temperatures in the range from 400 to 900° C., in order to obtain metal oxides and gaseous acids; and
e) absorbing the gaseous acids formed in step d).

2. The method according to claim 1, characterized in that wherein the temperature of the gaseous heat transfer medium in method step a) is in the range from 180 to 500° C.

3. The method according to claim 1, wherein the gaseous heat-transfer medium in method step a) is air.

4. The method according to claim 1, wherein the temperature in method step d) is in the range from 500 to 800° C.

5. The method according to claim 1, wherein the absorbing of the gaseous acids obtained in method steps b) or e) takes place in water.

6. The method according to claim 1, wherein the temperature of the gaseous heat-transfer medium in method step a) is in the range from 300 to 400° C.

7. The method according to claim 1, wherein the temperature in method step d) is in the range from 650 to 750° C.
